(19) United States
(12) Patent Application Publication
(10) Pub. No.: US 2013/0327643 A1
(43) Pub. Date: Dec. 12, 2013

(54) Expulsion of trapped matter

(71) Applicants: Bertha Catalina Rostro, Houston, TX (US); Mehdie Kohanloo, Houston, TX (US)

(72) Inventors: Bertha Catalina Rostro, Houston, TX (US); Mehdie Kohanloo, Houston, TX (US)

(21) Appl. No.: 13/491,613

(22) Filed: Jun. 8, 2012

(51) Int. Cl. B01D 43/00; B82Y 30/00

(52) U.S. Cl. 204/518; 204/545; 977/778

(57) ABSTRACT

Herein is described a process method and device used for nonporous, or porous media, that is metallic, ceramic, or of rock based compositions, such as geologic materials which may house inclusions such that under electromigration, thermophoresis, electrophoresis, magnetophoresis, electromagnetics, leads to combined advection, convection, electro-magnetic kinetics, osmosis, and diffusion. Meaning that under the influence of a solvent, cell, enclosure, contacts, and second enclosure material, yields the expulsion of trapped housed matter such as kerogen, oil, gas condensates, water-oil mixtures, hydrocarbons, terpenes, organic compounds, methane, inorganic material, solvent, or other organic material(s), or oil-gas-water type natural resource material. This is a simple environmental friendly method by which to expel housed and/or trapped media that is then released for collection, storage, and removal.

This patent makes mention of a process method and device see FIG. 1 Horizontal View, FIG. 2 Back View, and FIG. 3 Vertical View, whereby 1 specifies the First Outer Enclosure (−), 2 specifies the Inner Enclosure (+), 3 specifies the Enclosure, 4 specifies the Cathode Layer (+), and 5 specifies the Anode (−), 6 specifies the Enclosure for Rods, 7 specifies the Rod Smaller, 8 specifies the Cell, 9 specifies the Rod Larger, 10 specifies the Second Enclosure, 11 specifies the Enclosure, 12 specifies the Enclosure for Rods, 13 specifies the Rod Smaller, 14 specifies the Cell, 15 specifies the Rod Larger, for expelling trapped matter that is housed in nonporous, or porous media, that under electromigration, thermophoresis, electrophoresis, magnetophoresis, electromagnetics, leads to combined advection, convection, electro-magnetic kinetics, osmosis, and diffusion, which occurs under the influence of a solvent, cell, enclosure, contacts, and second enclosure material. This is a simple environmental friendly method by which to expel housed and/or trapped media that is then released for collection, storage, and removal.

### BRIEF DESCRIPTION OF THE DRAWINGS

FIG. 1 Rock Apparatus Horizontal View with legend showing 1—First Outer Enclosure (−), 2—Inner Enclosure (+), 3—Enclosure, 4—Cathode Layer (+), and 5—Anode (−) 6—Enclosure for Rods, 7—Rod Smaller, 8—Cell, 9—Rod Larger, 10—Second Enclosure, 11—Enclosure, 12—Enclosure for Rods, 13—Rod Smaller, 14—Cell, 15—Rod Larger.

FIG. 2 Rock Apparatus Horizontal View with legend showing 1—First Outer Enclosure (−), 2—Inner Enclosure (+), 3—Enclosure, 4—Cathode Layer (+), and 5—Anode (−) 6—Enclosure for Rods, 8—Cell, 10—Second Enclosure, 11—Enclosure, 12—Enclosure for Rods, 14—Cell.

FIG. 3 Rock Apparatus Vertical View with legend showing 1—First Outer Enclosure (−), 2—Inner Enclosure (+), 3—Enclosure, 4—Cathode Layer (+), and 5—Anode (−) 6—Enclosure for Rods, 7—Rod Smaller, 8—Cell, 9—Rod Larger, 10—Second Enclosure, 11—Enclosure, 12—Enclosure for Rods, 13—Rod Smaller, 14—Cell, 15—Rod Larger.

### BACKGROUND OF THE INVENTION

Current methods aimed at expelling trapped matter in nonporous or porous media that is tightly bound, requires the existence of a fractured or stress-dependent permeable network. This leads to certain fluid transfer, gas flow, permeabilities, and pressure differentials, which can enhance media migration and expulsion. However a detailed description of this migration and expulsion is lacking.

Currently, low permeability materials, have interconnections, often inclusions, or pores, and discontinuities, some of which are nanosized. These void volumes generate low-pressure or ultra low-pressure regimes, meaning that various transitional flow regimes start, yielding various flow-like behaviors.

The adsorption of certain gases due to kinetic energies means they can easily enter into narrow void spaces such that percolation, phase transitions, correlation lengths, and condensation-gelation are key. As are electrical conductivity, diffusivity, permeability, thermal conductivity, physisorption, chemisorption, and adsorption. Here interactions with gas-pore walls, chemical composition, molecular size(s)-shape(s) of the molecule(s)-inclusions-pore(s), and multilayer formation are important for transitional flows with nearest-neighbor interactions.

This means that transport mechanisms such as molecular-gaseous flow and diffusion, such as surface diffusion, multilayer diffusion, capillary condensation, condensate flow, liquid flow, and configurational diffusion occur. Such that for flows at 10⁻¹²-10⁻¹⁸ m²/s, configurational diffusion is active, and activation energies and concentrations, determine the migration-diffusion-sorption of molecules through media. Hence surface energies, pressure, entrapped matter charge, and chemical composition are key. Then kinetics and dynamics of diffusion, osmosis, and migration will then cause expulsion.

Here electromigration, or phoretic movement from electro-magnetic, and or thermal anomalies, allow for the creation of advection, convection, kinetics, osmosis, and diffusion creating gradients that depend on media structure, polarizabilities, and chemical composition.

### DESCRIPTION OF PRIOR ART

A fluctuating electric power source and fired heater for recovering of viscous fluids such as oil, has been disclosed in United States (US) Patent Application 20120138293. US Patent Application 20120132732, describes the use of generating and reusing materials and/or products leading to a series of electrical discharges in a material reactor, where an ambient liquid, causes a mechanical shock wave and discharge to form such that fragmentation and electromagnetic fields present themselves; note that this is a device for generating this effect. US Patent Application 20120132416, discusses an apparatus, method and system, for stimulating the production of gas, oil, water, using vibrational energy that is delivered to a geologic formation, that when combined with one or more enhanced oil recovery treatments, such as pressure waves, yields down-hole type capabilities. Yet another US Patent Application, that being 20120125613 describes a portable oil extraction system that uses a high heat energy generator to supply heat to an underground oil-rich zone. US Patent Application 20120118879 describes a plant for extracting hydrocarbons, contained in an underground formation, using a generator, electromagnetic heating device, and radiating coaxial line. This application claims a process method comprising steps that move housed constituents within porous or nonporous media using electromigration, thermophoresis, electrophoresis, magnetophoresis, and/or electromagnetics, wherein such constituents are media that is metallic, ceramic, or of rock based compositions, such as but not limited to, geologic materials, shale, clay, fine-grained sedimentary rock, mineral rock, oil rich rock, and/or sand based rock/material, which may house discontinuous and/or continuous pores and neck pore throat sizes.

### SUMMARY OF THE INVENTION

This is a process method for the expulsion of trapped matter that is housed in nonporous, or porous media, such that under electromigration, thermophoresis, electrophoresis, magnetophoresis, electromagnetics, yields combined advection, convection, electro-magnetic kinetics, osmosis, and diffusion. Such behavior occurs under the influence of a solvent, cell, enclosure, contacts, and second enclosure material. In this manner the housed and/or trapped media can be expelled and released for collection.

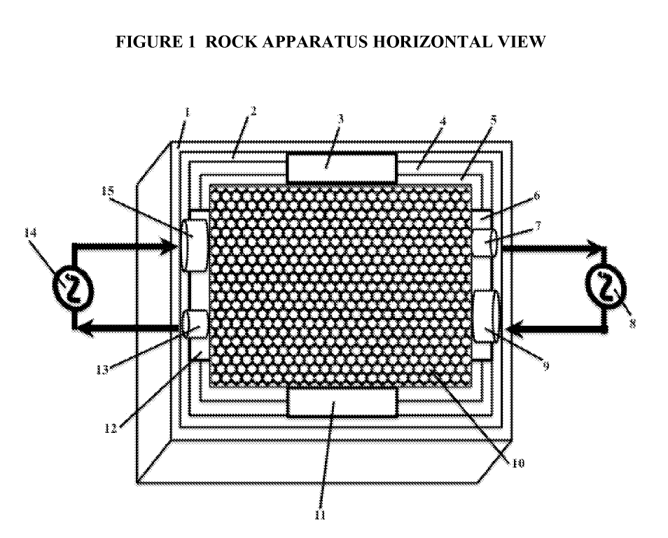

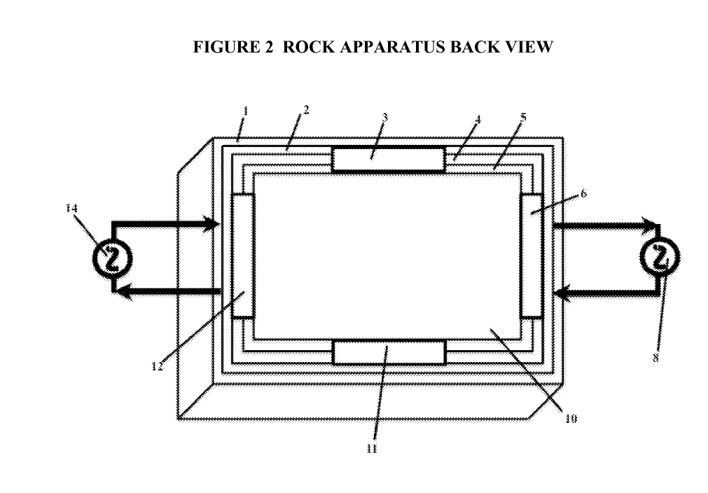

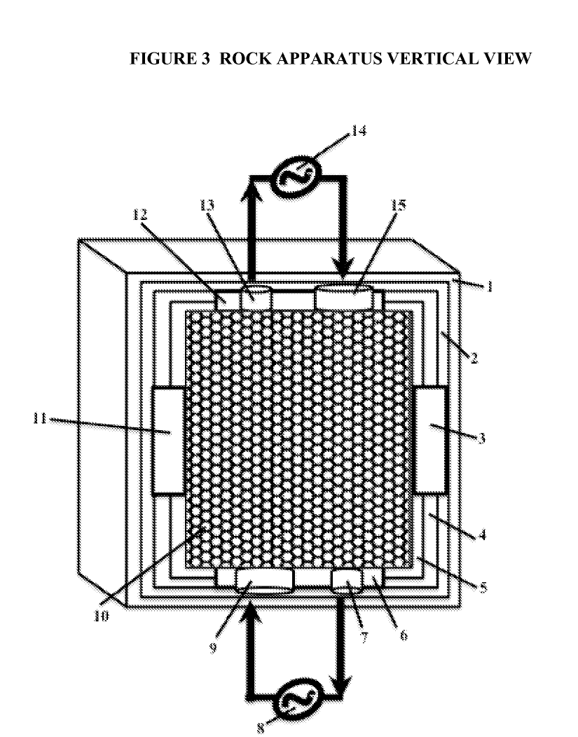

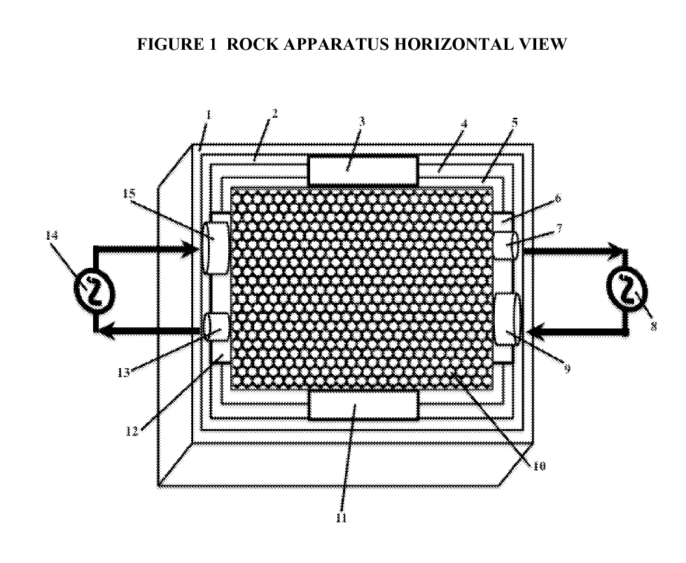

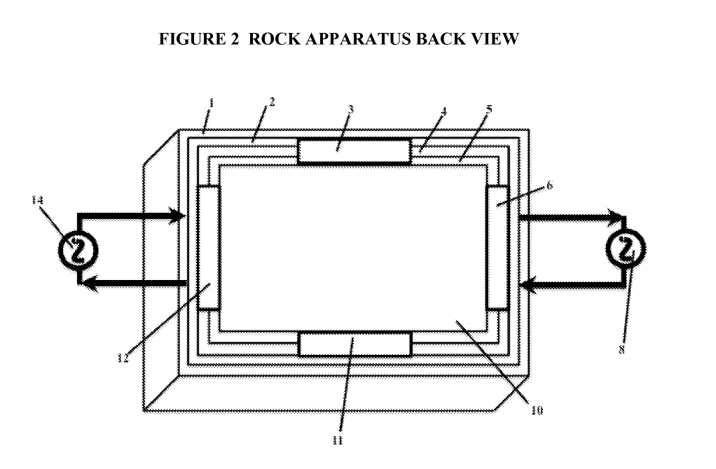

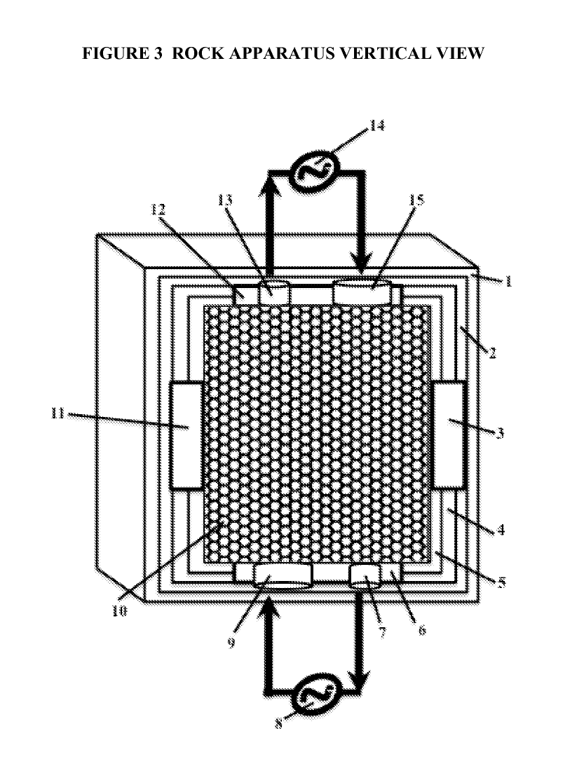

1. We claim a process method comprising steps that move constituent matter housed in nonporous or porous media, when under electromigration, thermophoresis, electrophoresis, magnetophoresis, electromagnetics, leads to combined advection, convection, electro-magnetic kinetics, osmosis, and diffusion, which occurs under the influence of a solvent, cell, enclosure, contacts, and second enclosure material as in FIG. 1, FIG. 2, and FIG. 3.

2. The method of claim 1 where electrostatic forces, electro-osmotic flow, and osmotic potential generates electro-magnetic kinetics and diffusion coefficient and gradient, which depends on the charge of constituent and media chemical composition and structure.

3. The method of claim 1 where the porous or nonporous media is subnanometer, nanometer, or micrometer sized, with inclusions or pores, such that said media can be metallic, ceramic, or of rock based compositions, such as but not limited to, geologic materials, shale, clay, fine-grained sedimentary rock, mineral rock, oil rich rock, and/or sand based rock/material, that may house discontinuous and/or continuous pores and neck pore throat sizes.

4. The method of claim 1 where media constituents become electrically and/or magnetically charged, to undergo movement or mobilization, gradient creation, and heat transfer, yielding their migration, such as electro-migration, and expulsion.

5. The method of claim 1 where constituents include trapped matter such as kerogen, oil, gas condensates, water-oil mixtures, hydrocarbons, terpenes, organic compounds, methane, inorganic material, solvent, or other organic material(s), or oil-gas-water type natural resource material.

6. The method of claim 1 where the solvent is a combination of electrolyte, buffer, salt-water solution, polar solvent, polar type oil, processed structured water, and a dye-based tracer that responds to respective electric-magnetic charge.

7. The method of claim 6 whereby the dye has a dipole and polarization potential that responds to electro-magnetic effects, such as but not limited to compounds derived from fluorone, cyanine, xanthin, tannins, iodine.

8. The method of claim 4 where electro-magnetic effects are generated by the use of a battery, electrochemical cell, electrolyte, salt, gel, galvanic cell, solar cell, photovoltaic cell, photoelectric cell, magnetic cell as in 14 and 8 in FIG. 1, and FIG. 2, and FIG. 3.

9. The method of claim 4 where contacts are rods that are of differing size, one smaller the other larger in size, which are made of polymer, metal, or composite which is capable of carrying charge, which are placed within the media, thereby used as electrodes, as in 7, 9, and 13, 15 in FIG. 1, and FIG. 2, and FIG. 3.

10. The method of claim 4 where such charge is carried through conducting metal plates, discs, or metal enclosure, conductive polymer, or conductive composite, superconductor enclosure, magnetic type enclosure, or nanoporous enclosure, that makes possible electro-magnetic effects, as in 1, 2, 3, 4, 5, 6, 11, and 12 in FIG. 1, and FIG. 2, and FIG. 3.

11. The method of claim 4 where the second enclosure confers electromagnetic shielding, magnetic shielding, and/or faraday cage effect, composed of materials, such as but not limited to, magnetically permeable metal alloys, conducting mesh, or conducting porous metal enclosures, as in 10 in FIG. 1, and FIG. 2, and FIG. 3.
